(19) United States
(12) Patent Application Publication
(10) Pub. No.: US 2023/0260244 A1
(43) Pub. Date: Aug. 17, 2023

(54) SOLID-STATE IMAGING ELEMENT, IMAGING DEVICE, AND INFORMATION PROCESSING SYSTEM

(71) Applicant: SONY SEMICONDUCTOR SOLUTIONS CORPORATION, KANAGAWA (JP)

(72) Inventors: HAREESH JAGADEESH, TOKYO (US); KAZUYUKI OKUIKE, KANAGAWA (JP)

(21) Appl. No.: 18/004,769

(22) PCT Filed: May 18, 2021
(86) PCT No.: PCT/JP2021/018717

§ 371 Date: Jan. 9, 2023

(30) Foreign Application Priority Data
Jul. 17, 2020 (JP) 2020-122492

(51) Int. Cl. G06V 10/147; G06V 10/84; G06V 10/96; G06V 10/94; H04N 25/70; H04N 23/80; G06V 10/70

(52) U.S. Cl. CPC G06V 10/147; G06V 10/84; G06V 10/96; G06V 10/955; H04N 25/70; H04N 23/80; G06V 10/87

(57) ABSTRACT

For a solid-state imaging element that executes image recognition processing, versatility is improved.

The solid-state imaging element includes a processing section, a digital signal processing section, and an output interface. The processing section selects any one of a plurality of DNNs (Deep Neural Networks) with different formats of an output tensor. The digital signal processing section executes image recognition processing on an input tensor by use of the selected DNN to generate the output tensor. The output interface outputs a decode parameter for decoding the generated output tensor and the output tensor.

### TECHNICAL FIELD

The present technology relates to a solid-state imaging element. In particular, the present technology relates to a solid-state imaging element, an imaging device, and an information processing system that output results of image recognition processing.

### BACKGROUND ART

In the related art, a DNN (Deep Neural Network) is used in various fields such as image recognition and voice recognition. For example, an imaging device has been proposed that captures image data and performs image recognition processing on the image data by use of the DNN (see, for example, PTL 1). The imaging device makes the results of image recognition processing into metadata, and outputs the metadata to an application server along with the image data.

### CITATION LIST

### Patent Literature

[PTL 1]
   JP 2020-22054A

### SUMMARY

### Technical Problem

With the imaging device executing the image recognition processing, the above-described related art reduces an amount of processing executed by the application server and a possible delay time in the processing, compared to a case where the application server executes the image recognition processing. Here, the formats (the number of data, data type, data size, and the like) of input data to and output data from the DNN are determined depending on the contents of processing of the DNN, and are not generally changed after shipment. However, in a case where recognition accuracy is insufficient at a value set before shipment or an object to be recognized is changed, or in any other case, the contents of processing of the DNN may need to be changed. Then, the change in the contents of the processing may lead to a need for a change in the formats of input and output data. A problem with the above-described imaging device is that the device does not allow the formats of input data to and output data from the DNN to be changed and is thus poor in versatility.

In view of these circumstances, the present technology is conceived of, and an object of the present technology is to improve versatility in a solid-state imaging element that executes image recognition processing.

### Solution to Problem

The present technology is to solve the above-described problem, and a first aspect of the present technology provides a solid-state imaging element including a processing section configured to select any one of a plurality of DNNs (Deep Neural Networks) with different formats of an output tensor, a digital signal processing section configured to execute image recognition processing on an input tensor by use of the selected DNN to generate the output tensor, and an output interface configured to output a decode parameter for decoding the generated output tensor and the output tensor. This is effective in improving the versatility of the solid-state imaging element.

In addition, in the first aspect, the solid-state imaging element may further include an input interface configured to receive, as a DNN parameter, a parameter for causing the digital signal processing section to execute each of the plurality of DNNs, and the digital signal processing section may execute the image recognition processing on the basis of the DNN parameter. This is effective in allowing the plurality of DNNs to be executed.

In addition, in the first aspect, the output interface may further output the input tensor. This is effective in causing the input tensor to be processed outside the solid-state imaging element.

In addition, in the first aspect, the solid-state imaging element may further include a memory configured to store the input tensor in a predetermined area. The output interface may output the input tensor read out from the memory, and the decode parameter may include a persistency flag indicating whether or not the area is not to be overwritten before the image recognition processing is complete. This is effective in allowing a case to be dealt with in which the DNN is not complete within one frame period.

In addition, in the first aspect, the output interface may output the input tensor and the output tensor to each of which a header is added. This is effective in causing the header to be processed outside the solid-state imaging element.

In addition, in the first aspect, the header added to the input tensor may include a validity flag indicating whether or not the input tensor is valid, and the header added to the output tensor may include a validity flag indicating whether or not the output tensor is valid. This is effective in preventing malfunction outside the solid-state imaging element.

In addition, in the first aspect, the header added to the input tensor and the header added to the output tensor corresponding to the input tensor may include a frame count of the same value. This is effective in allowing the input tensor and the output tensor to be associated with each other outside the solid-state imaging element.

In addition, in the first aspect, the input tensor may include a first input tensor and a second input tensor, the plurality of DNNs may include a first DNN and a second DNN, and the digital signal processing section may use the first DNN for the first input tensor and use the second DNN for the second input tensor. This is effective in causing the plurality of DNNs to be sequentially executed.

In addition, in the first aspect, the digital signal processing section may execute image recognition processing on the input tensor to generate the output tensor, and the output interface may output the output tensor after a predetermined frame period elapses in which the input tensor is generated. This is effective in allowing a case to be dealt with in which the DNN is not complete within one frame period.

In addition, in the first aspect, the digital signal processing section may suspend the image recognition processing before a capture period in which a frame is held in the memory begins, and may resume the image recognition processing after the capture period elapses. This is effective in suppressing possible band noise.

In addition, a second aspect of the present technology provides metadata including an output tensor generated by image recognition processing executed on an input tensor and a decode parameter for decoding the output tensor. This is effective in decoding the output tensor.

In addition, a third aspect of the present technology provides an imaging device including a processing section configured to select any one of a plurality of DNNs (Deep Neural Networks) with different formats of an output tensor, a digital signal processing section configured to execute image recognition processing on an input tensor by use of the selected DNN to generate the output tensor, an output interface configured to output a decode parameter for decoding the generated output tensor and the output tensor, and an application processor configured to decode the output tensor that has been output, by use of the decode parameter. This is effective in improving the versatility of the imaging device.

In addition, a fourth aspect of the present technology provides an information processing system including a processing section configured to select any one of a plurality of DNNs (Deep Neural Networks) with different formats of an output tensor, a digital signal processing section configured to execute image recognition processing on an input tensor by use of the selected DNN to generate the output tensor, an output interface configured to output a decode parameter for decoding the generated output tensor and the output tensor, an input interface configured to receive the decode parameters corresponding to each of the plurality of DNNs, and a converter configured to generate each of the decode parameters and supply the generated decode parameter to the input interface. This is effective in improving the versatility of the information processing system.

### BRIEF DESCRIPTION OF DRAWINGS

FIG. 1 is a block diagram depicting a configuration example of an information processing system according to an embodiment of the present technology.

FIG. 2 is a block diagram depicting a configuration example of an image sensor according to the embodiment of the present technology.

FIG. 3 is a block diagram depicting a configuration example of an interface according to the embodiment of the present technology.

FIG. 4 is a diagram illustrating functions of a DNN converter according to the embodiment of the present technology.

FIG. 5 is a diagram illustrating a processing procedure of an information processing system according to the embodiment of the present technology.

FIG. 6 is a diagram depicting an example of data transferred via an interface conforming to an MIPI (Mobile Industry Processor Interface) standard according to the embodiment of the present technology.

FIG. 7 depicts an example of an MIPI standard mobile format according to the embodiment of the present technology.

FIG. 8 depicts an example of an MIPI standard AV (Audio Visual) format according to the embodiment of the present technology.

FIG. 9 depicts an example of a data format of metadata including an input tensor according to the embodiment of the present technology.

FIG. 10 is a diagram illustrating details of metadata corresponding to the input tensor according to the embodiment of the present technology.

FIG. 11 is a diagram depicting a configuration example of the input tensor according to the embodiment of the present technology.

FIG. 12 is a diagram depicting another example of the input tensor according to the embodiment of the present technology.

FIG. 13 depicts an example of a data format of metadata including an output tensor according to the embodiment of the present technology.

FIG. 14 is a diagram illustrating details of metadata corresponding to the output tensor according to the embodiment of the present technology.

FIG. 15 is a diagram depicting a configuration example of the output tensor according to the embodiment of the present technology.

FIG. 16 is a diagram depicting an example of data associated with a network in DNN parameters according to the embodiment of the present technology.

FIG. 17 is a diameter depicting an example of data associated with a dimension in the DNN parameters according to the embodiment of the present technology.

FIG. 18 is a diameter depicting an example of data associated with a tensor in the DNN parameters according to the embodiment of the present technology.

FIG. 19 is a diameter depicting an example of data associated with an input tensor and an output tensor in the DNN parameters according to the embodiment of the present technology.

FIG. 20 is a diameter depicting an example of data associated with memory details in the DNN parameters according to the embodiment of the present technology.

FIG. 21 is a diagram depicting an example of data associated with a network in AP (Application Processor) parameters according to the embodiment of the present technology.

FIG. 22 is a diagram depicting an example of data associated with a dimension in the AP parameters according to the embodiment of the present technology.

FIG. 23 is a diagram depicting an example of data associated with a tensor in the AP parameters according to the embodiment of the present technology.

FIG. 24 is a diagram depicting an example of data associated with an input tensor and an output tensor in the AP parameters according to the embodiment of the present technology.

FIG. 25 is a timing chart depicting an example of operation of the image sensor to output of an RAW image according to the embodiment of the present technology.

FIG. 26 is a timing chart depicting an example of operation of the image sensor to output of the output tensor according to the embodiment of the present technology.

FIG. 27 is a timing chart depicting an example of operation of the image sensor to output of the first RAW image according to a first modification of the embodiment of the present technology.

FIG. 28 is a timing chart depicting an example of operation of the image sensor to output of the output tensor corresponding to the first RAW image according to the first modification of the embodiment of the present technology.

FIG. 29 is a timing chart depicting an example of operation of the image sensor to output of the second RAW image according to the first modification of the embodiment of the present technology.

FIG. 30 is a timing chart depicting an example of operation of the image sensor to output of the output tensor corresponding to the second RAW image according to the first modification of the embodiment of the present technology.

FIG. 31 is a timing chart depicting an example of operation of the image sensor to output of the first input tensor according to a second modification of the embodiment of the present technology.

FIG. 32 is a timing chart depicting an example of operation of the image sensor to output of the second RAW image according to the second modification of the embodiment of the present technology.

FIG. 33 is a timing chart depicting an example of operation of the image sensor to output of the output tensor corresponding to the first RAW image according to the second modification of the embodiment of the present technology.

FIG. 34 is a timing chart depicting an example of operation of the image sensor to output of the first input tensor according to a third modification of the embodiment of the present technology.

FIG. 35 is a timing chart depicting an example of operation of the image sensor to output of the second RAW image according to the third modification of the embodiment of the present technology.

FIG. 36 is a timing chart depicting an example of operation of the image sensor to output of the output tensor corresponding to the first RAW image according to the third modification of the embodiment of the present technology.

### DESCRIPTION OF EMBODIMENTS

Modes for implementing the present technology (hereinafter also referred to as embodiments) will be described. The description is given in the following order.
1. Embodiment (example in which parameters for decoding are output)
2. First Modification (example in which, for each frame, a DNN is changed and the parameters for decoding are output)
3. Second Modification (example in which an output tensor and the parameters for decoding are output in a frame following an input tensor)
4. Third Modification (example in which, during capture, the DNN is suspended and the parameters for decoding are output)

### 1. Embodiment

### Configuration Example of Information Processing System

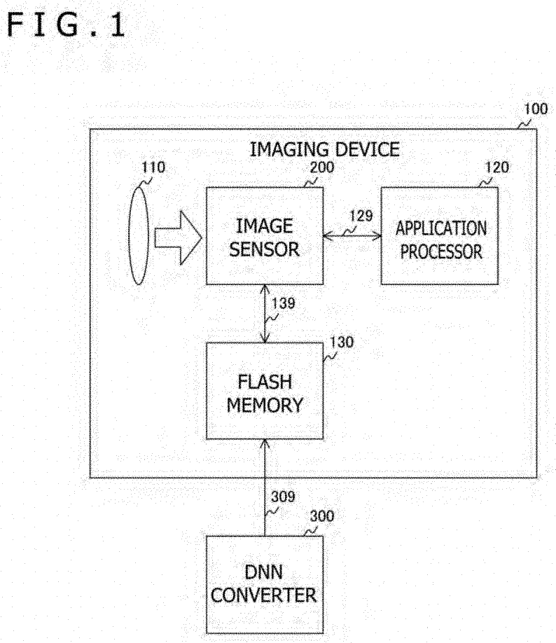

FIG. 1 is a block diagram depicting a configuration example of an information processing system according to an embodiment of the present technology. The information processing system is a system for executing image recognition processing, and includes an imaging device 100 and a DNN converter 300.

The imaging device 100 captures image data and executes image recognition processing on the image data. The imaging device 100 includes an optical section 110, an image sensor 200, an application processor 120, and a flash memory 130.

The optical section 110 focuses incident light and guides the focused light to the image sensor 200.

The image sensor 200 captures image data by photoelectric conversion and executes the image recognition processing on the image data. The image sensor 200 captures image data under control of the application processor 120, and executes the image recognition processing on the image data. Then, the image sensor 200 outputs data including processing results to the application processor 120 via a signal line 129. Note that the image sensor 200 is an example of a solid-state imaging element recited in claims.

In addition, before image capturing, the image sensor 200 reads out from the flash memory 130 data required for the image recognition processing via a signal line 139, and holds the read-out data.

The application processor 120 decodes the processing results of the image recognition processing and executes various applications on the basis of decoding results.

The DNN converter 300 generates data required for the image recognition processing. The DNN converter 300 writes the data generated to the flash memory 130 via a signal line 309, before the image capturing.

### Configuration Example of Image Sensor

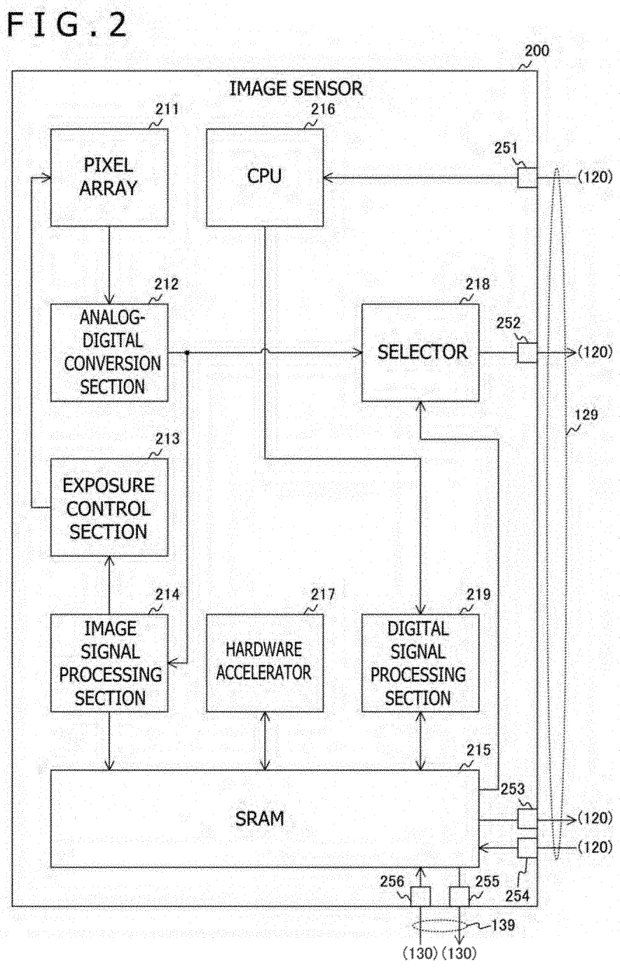

FIG. 2 is a block diagram depicting a configuration example of the image sensor 200 according to the embodiment of the present technology. The image sensor 200 includes a pixel array 211, an analog-digital conversion section 212, an exposure control section 213, an image signal processing section 214, and an SRAM (Static Random Access Memory) 215. In addition, the image sensor 200 includes a CPU (Central Processing Unit) 216, a hardware accelerator 217, a selector 218, and a digital signal processing section 219. In addition, the image sensor 200 includes input interfaces 251, 254, and 256 and output interfaces 252, 253, and 255. These circuits are provided, for example, on a single semiconductor chip.

Note that the above-described circuits in the image sensor 200 can be arranged on a plurality of semiconductor chips laminated on one another in a distributed manner. In this case, for example, an upper semiconductor chip is laminated on a lower semiconductor chip, and the pixel array 211 is arranged on the upper semiconductor chip, whereas the other circuits are arranged on the lower semiconductor chip.

The pixel array 211 includes a plurality of pixels arrayed in a two-dimensional grid. Each of the pixels generates an analog pixel signal by photoelectric conversion, and supplies the pixel signal to the analog-digital conversion section 212.

The analog-digital conversion section 212 converts each analog pixel signal into a digital signal. The analog-digital conversion section 212 is provided with an ADC (Analog to Digital Converter) for each column or for each pixel. Each of the ADCs AD (Analog to Digital)-converts the corresponding pixel signal into a digital signal. Image data with such digital signals arrayed therein is supplied to the selector 218 and the image signal processing section 214 as an RAW image.

The image signal processing section 214 performs various types of image processing operations on the RAW image. The image processing executed includes lens shading correction, white balance gain correction, demosaic processing, linear matrix processing, gamma correction, reduction processing, image cropping processing, and distortion correction. Any one or more of these processing operations are performed. An image subjected to the image processing is hereinafter also referred to as an “input tensor.” The image signal processing section 214 writes, into the SRAM 215, a RAW image, which has not been processed, and an input tensor, which has been processed.

In addition, the image signal processing section 214 determines illuminance of ambient light on the basis of the RAW image. For example, the image signal processing section 214 calculates a statistical amount (total value) of a digital signal in at least a partial area of the RAW image, and supplies the result of the calculation to the exposure control section 213 as illuminance data.

The exposure control section 213 controls an exposure time for the pixel array 211 on the basis of the illuminance.

The SRAM 215 stores various types of data such as RAW images. Besides the RAW images, the SRAM 215 includes input tensors, output tensors, network weights, DNN program codes, DNN parameters, AP parameters, manifests, and the like. The DNN parameters, the AP parameters, and the programs are desirably encrypted before being held in the SRAM 215. In a case where the parameters or programs are encrypted, the digital signal processing section 219 decrypts the parameters or programs when reading out the parameters or programs.

The output tensor is a tensor output from a DNN to be used in the image recognition processing, and is data indicating the processing results of the image recognition processing.

The network weight is a coefficient by which a value output from a neural in the DNN is multiplied.

The DNN program code is a code used to describe a program to cause the digital signal processing section 219 to execute the DNN.

The DNN parameters are parameters for causing the digital signal processing section 219 to execute the image recognition processing, and include information related to the dimension of the DNN, the network weight, and the input and output tensors, and the like.

The AP parameters are parameters used by the application processor 120 to decode the input tensor and the output tensor.

The manifest is information related to the size and load address of a file in which the network weight, the DNN program code, the DNN parameters, and the AP parameters are stored,

The CPU 216 controls the circuits in the image sensor 200. The CPU 216 receives an input command from the application processor 120 via the input interface 251. The CPU 216 controls the digital signal processing section 219 according to the command to execute the image recognition processing.

Here, the digital signal processing section 219 includes a function to execute the image recognition processing by use of M (M is an integer) DNNs with different formats and algorithms for the output tensor. The formats of the input tensor to and the output tensor from each of the DNNs are determined depending on the contents (algorithm and the like) of processing of the DNN. The CPU 216 selects any one of the DNNs and instructs the digital signal processing section 219 to execute the selected DNN. The DNN to be executed is switched while the image capturing is stopped (in other words, statically) rather than during the image capturing (in other words, dynamically). The DNN is switched as necessary in a case where the DNN used before the switching is insufficient in recognition accuracy or an object to be recognized is to be changed, or in any other case.

Each of the sets of the DNN parameters and the AP parameters described above is divided into M groups. The m-th (m is an integer of from 0 to M−1) group is a set of parameters corresponding to the m-th DNN. The network weights are similarly divided into M groups. Common DNN program codes can be used for a plurality of DNNs, and M or less DNN program codes are held.

Note that the image sensor 200 stores various types of data in the SRAM 215 and can also store the data in a memory other than the SRAM. Note that the SRAM 215 is an example of a memory in the claims.

The hardware accelerator 217 executes image rotation processing on the input tensor as necessary. For example, when character recognition is performed, the rotation processing is executed in order to improve recognition accuracy. The hardware accelerator 217 reads out from the SRAM 215 the input tensor to be processed, and performs update by use of the input tensor rotated.

The selector 218 selects data from the RAW image and the data held in the SRAM 215, and outputs the selected data to the application processor 120. The selector 218 reads the input tensor and the output tensor corresponding to the RAW image from the SRAM 215 along with the AP parameters corresponding to the tensors, as metadata. Then, the selector 218 outputs at least one of the RAW image and the metadata to the application processor 120 via the output interface 252. The selector 218 can select and output only one of the image data and the metadata or can select and output both the image data and the metadata.

The digital signal processing section 219 executes the image recognition processing by use of the DNN selected by the CPU 216. The digital signal processing section 219 references the manifest to read out from the SRAM 215 the DNN parameters, network weight, input tensor, and DNN program code corresponding to the selected DNN. When the m-th DNN is selected, the DNN parameters in the m-th group, and the like are read out.

Then, the digital signal processing section 219 executes the image recognition processing on the input tensor on the basis of the read data (DNN parameters and the like) to generate an output tensor. The digital signal processing section 219 writes the output tensor generated into the SRAM 215.

The output interface 253 outputs the output tensor to the application processor 120 along with the corresponding AP parameters, as metadata. When the m-th DNN is selected, the AP parameters in the m-th group are output.

The input interface 254 receives various types of data such as download programs from the application processor 120, and supplies the data to the SRAM 215.

The output interface 255 outputs, to the flash memory 130, the data held in the SRAM 215.

The input interface 256 receives data such as the AP parameters and the DNN parameters from the flash memory 130, and supplies the data to the SRAM 215.

As the input interface 251, for example, an interface that conforms to the I2C (Inter-Integrated Circuit) standard is used. As the output interface 252, for example, an interface that conforms to the MIFI standard is used. As the output interface 253 and the input interface 254, for example, interfaces that conform to the SPI (Serial Peripheral Interface) standard are used. As the output interface 255 and the input interface 256, for example, interfaces that conform to the SPI standard are used.

### Configuration Example of Interface

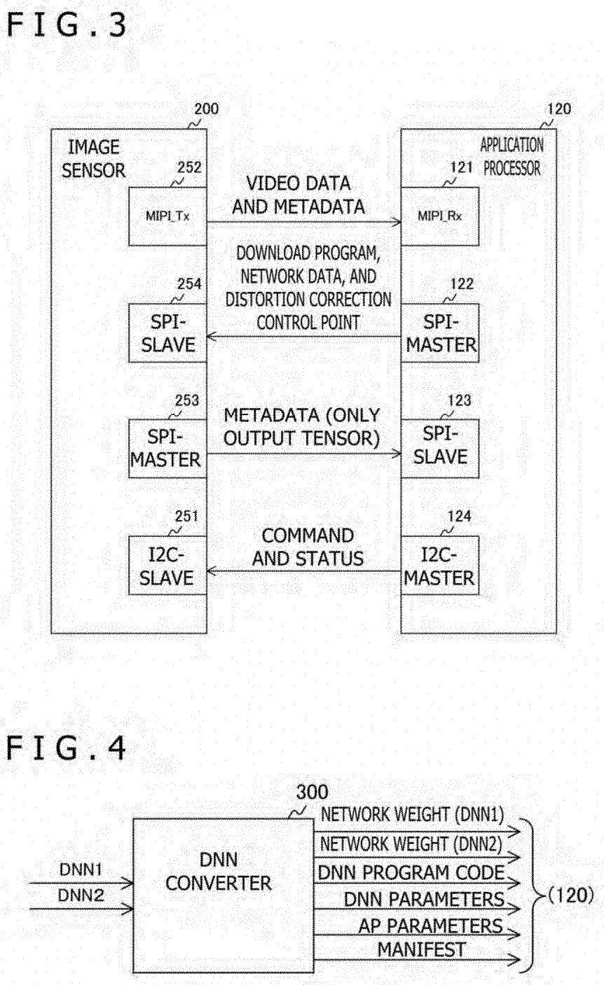

FIG. 3 is a block diagram depicting a configuration example of the interface according to the embodiment of the present technology. The image sensor 200 is provided with the output interface 252, input interface 254, output interface 253, and input interface 251 described above.

In addition, the application processor 120 is provided with the input interface 121, the output interface 122, the input interface 123, and the output interface 124.

In the output interface 252, a transmission circuit that conforms to the MIPI standard is disposed. In the input interface 121, a reception circuit that conforms to the MIPI standard is disposed. In FIG. 3, “MIPI_Tx” represents the transmission circuit, and “MIPI_Rx” represents a reception circuit. Video data and metadata are transferred via the output interface 252 and the input interface 121. The video data includes a plurality of RAW images continuously captured (in other words, frames). The metadata is generated and transferred for each frame.

The input interface 254 functions as a slave conforming to the SPI standard, and the output interface 122 functions as a master conforming to the SPI standard. Download programs, network data, distortion correction control points, and the like are transferred via the input interface 254 and the output interface 122.

The output interface 253 functions as an SPI standard master, and the input interface 123 functions as an SPI standard slave. Metadata is transferred via the output interface 253 and the input interface 123. The metadata includes no input tensor and includes an output tensor and corresponding AP parameters.

The input interface 251 functions as an I2C standard slave, and the output interface 124 functions as an I2C standard master. Commands to the CPU 216, the status of the application processor 120, and the like are transferred via the input interface 251 and the output interface 124.

The image sensor 200 can output both video data and metadata and can also output only the metadata. The MIPI standard interface is used when both video data and metadata are output, as depicted in FIG. 3, and the SPI standard interface is used when only the metadata is output. Whether or not to transmit video data (RAW image) is set by the CPU 216 before the image capturing is started.

Besides, the image sensor 200 can output any one of the following pieces of data each time a RAW image is captured.
(1) Only RAW image
(2) Only input tensor and AP parameters
(3) Only output tensor and AP parameters
(4) Combination of (1) to (3)

These output settings are provided by the application processor 120 transmitting a command via the I2C standard interface and the CPU 216 making settings in a register according to the command. Whether the data is any one of an input tensor and an output tensor is set by use of an identifier flag described below.

Note that each of the image sensor 200 and the application processor 120 is provided with both the SPI standard interface and the MIPI standard interface and can be provided only with one of the interfaces.

FIG. 4 is a diagram illustrating the functions of the DNN converter 300 according to the embodiment of the present technology. The DNN converter 300 receives inputs of pieces of data indicating the specifications of each of M DNN models developed by public frameworks. The DNN converter 300 converts input data into a network weight, a DNN program code, DNN parameters, AP parameters, and a manifest.

For example, in a case where two models DNN1 and DNN2 are input, the DNN converter 300 outputs a network weight corresponding to DNN1 and a network weight corresponding to DNN2. In addition, the DNN converter 300 outputs the DNN program code common to DNN1 and DNN2, the DNN parameters, the AP parameters, and the manifest. As the DNN parameters, a plurality of parameters is generated. The set of DNN parameters is divided into a group corresponding to DNN1 and a group corresponding to DNN2. Similarly, a plurality of AP parameters is generated, and the set of AP parameters is divided into a group corresponding to DNN1 and a group corresponding to DNN2.

The DNN converter 300 writes generated data to the flash memory 130 in the image sensor 200 before the image capturing is started. The DNN converter 300 is implemented by an offline conversion tool or the like.

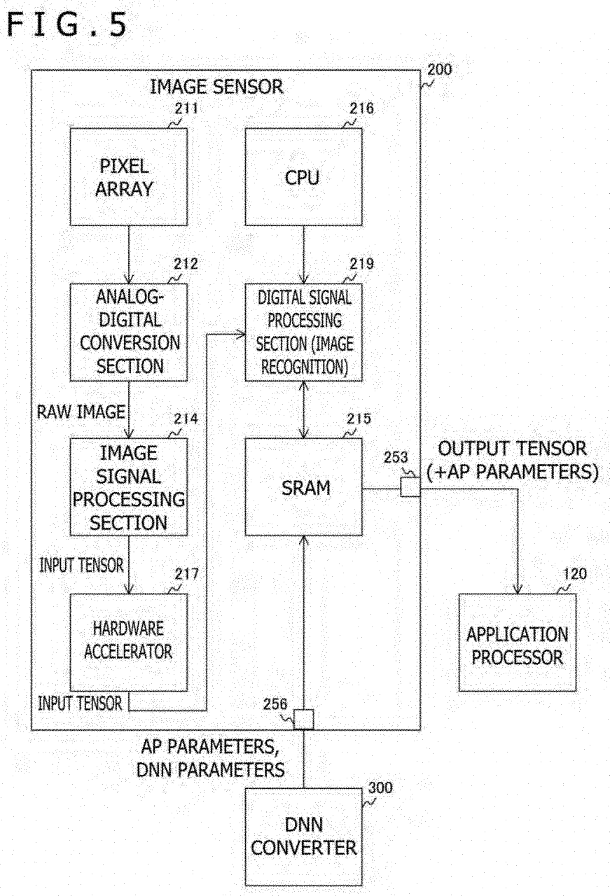

FIG. 5 is a diagram illustrating a processing procedure of an information processing system according to the embodiment of the present technology. Before the image capturing is started, the DNN converter 300 generates and writes data such as the AP parameters and the DNN parameters to the flash memory 130 (not depicted). The data in the flash memory 130 is read out by the image sensor 200 before the image capturing, and held in the SRAM 215.

When the application processor 120 provides an indication to start image capturing, each of the pixels in the pixel array 211 generates and outputs an analog pixel signal to the analog-digital conversion section 212.

The analog-digital conversion section 212 converts each pixel signal into a digital signal, and supplies the image signal processing section 214 with a RAW image including an array of digital signals.

The image signal processing section 214 buffers the RAW image in the SRAM 215, and executes image processing such as mosaic processing on the RAW image to generate an input tensor. The image signal processing section 214 writes the input tensor to the SRAM 215.

The hardware accelerator 217 reads out the input tensor from the SRAM 215, and rotates the input tensor as necessary to update the SRAM 215.

The CPU 216 selects any one of M DNNs with different formats of the output tensor, and instructs the digital signal processing section 219 to execute the selected DNN. Note that the CPU 216 is an example of a processing section recited in the claims.

The digital signal processing section 219 reads out from the SRAM 215 the network weight, DNN parameters, and DNN program code corresponding to the indicated DNN. Then, on the basis of the read-out data, the digital signal processing section 219 uses the DNN selected by the CPU 216 to execute the image recognition processing on the input tensor, and generates an output tensor. The digital signal processing section 219 writes the output tensor to the SRAM 215.

The SPI standard output interface 253 reads out the output tensor generated and the AP parameters for decoding the tensor, from the SRAM 215 as metadata according to control of the CPU 216, and outputs the metadata to the application processor 120.

The application processor 120 uses the AP parameters to decode the output tensor.

Note that, when the RAW image or the input tensor is also output, the MIPI standard output interface 252 is used.

Here, in an assumed comparative example, the output interface 253 outputs no AP parameters and outputs only the output tensor. In the comparative example, switching the DNN changes the format of the output tensor, thus preventing the application processor 120 from decoding the output tensor.

In contrast, in an information processing system in which the output interface 253 outputs the AP parameters in addition to the output tensor, the application processor 120 can decode the output tensor by use of the AP parameters. Thus, the information processing system can deal with various DNNs with different formats of the output tensor, allowing the versatility of the system to be improved.

In addition, in a case where the output interface 253 outputs the input tensor and the AP parameters, the application processor 120 can decode the input tensor by use of the AP parameters even when the DNN is switched.

In addition, with the image sensor 200 executing the image recognition processing, this configuration can reduce an amount of processing executed by the application processor 120 and a possible delay time in the processing, compared to a case where the application processor 120 executes the image recognition processing.

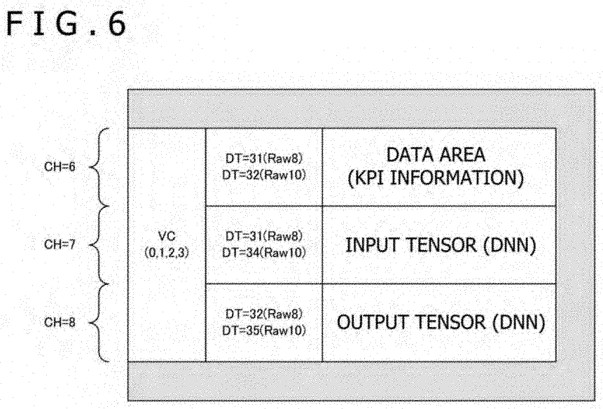

FIG. 6 is a diagram depicting an example of data transferred via an interface conforming to the MIPI standard according to the embodiment of the present technology. As illustrated in FIG. 6, the input tensor is transferred via a virtual channel according to the MIPI standard. The output tensor is transferred to via a virtual channel different from that for the input tensor.

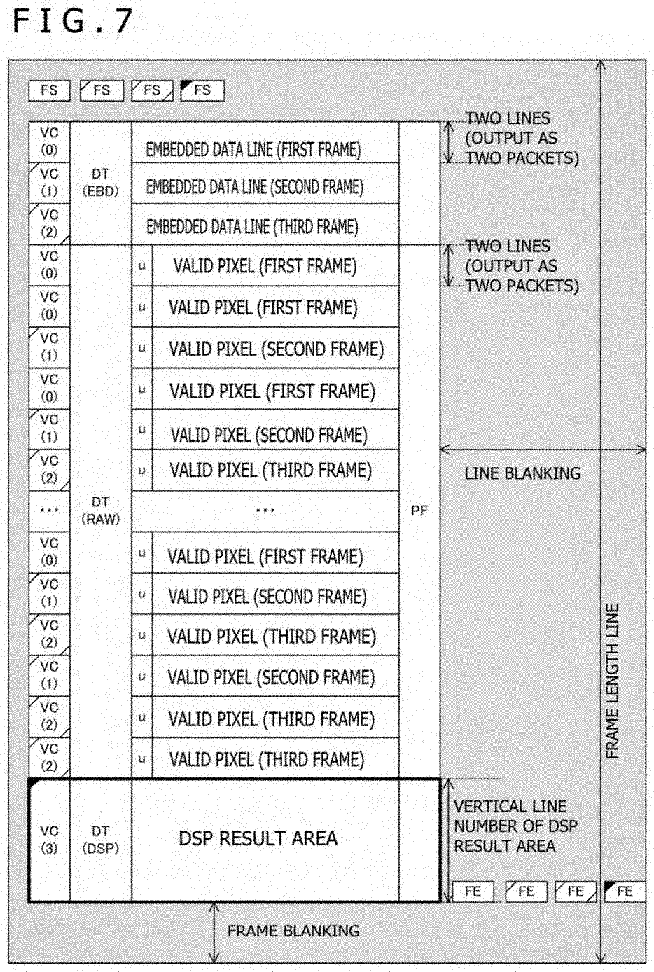

FIG. 7 is an example of an MIPI standard mobile format according to the embodiment of the present technology. The data illustrated in FIG. 6 is stored in a DSP result area enclosed by a thick line in FIG. 7.

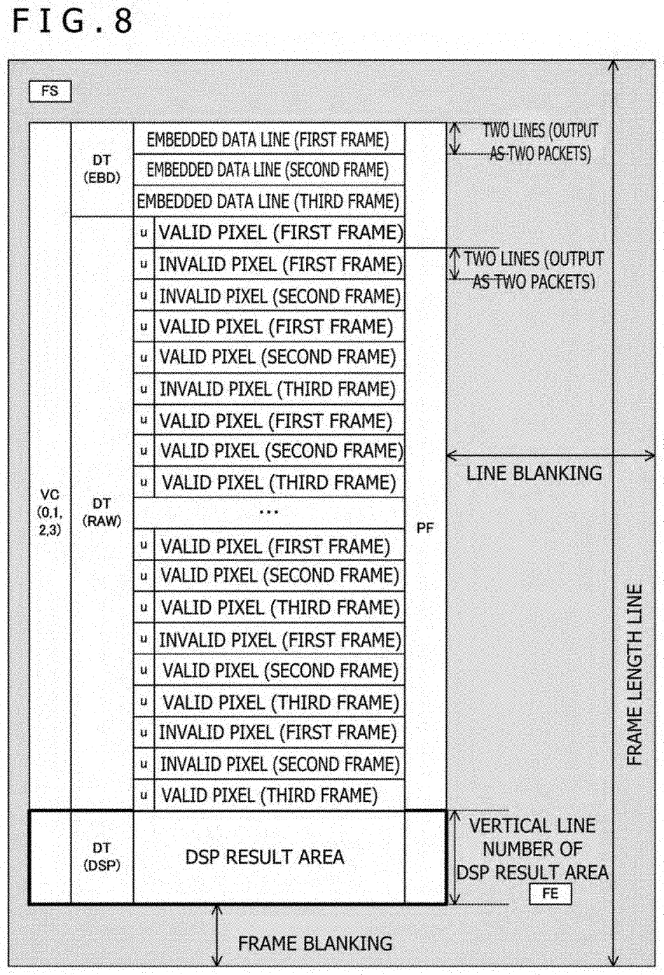

FIG. 8 is an example of an MIPI standard AV format according to the embodiment of the present technology. The data illustrated in FIG. 6 is stored in a DSP result area enclosed by a thick line in FIG. 8.

Note that, in a case where the SPI standard interface is used, data is sequentially transferred according to transfer settings defined in the SPI standard. The transfer rate of the SPI standard interface is lower than that of the MIPI standard interface, and thus, the use of the SPI standard interface does not involve transmission of RAW images.

### Configuration Example of Metadata

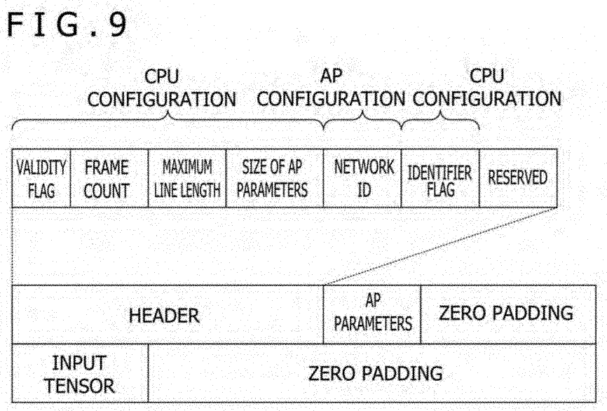

FIG. 9 is an example of a data format of metadata including an input tensor according to the embodiment of the present technology. The metadata includes a header, AP parameters, and an input tensor. The header includes a validity flag, a frame count, a maximum line length, the size of AP parameters, a network ID (IDentifier), and an identifier flag. In addition, in the metadata, empty areas are padded with zeros. In the header, empty areas are used as reserved areas.

The validity flag indicates whether or not the input tensor is valid.

The frame count is a count value obtained when the CPU 216 counts the number of times that a RAW image (frame) is captured. The frame count is used to identify the output tensor corresponding to the input tensor when the frame in which the input tensor is output is different from the frame in which the output tensor is output. The modification below describes the case where the frame in which the input tensor is output is different from the frame in which the output tensor is output.

The maximum line length is the length of an MIPI line dependent on the MIPI settings. The size of the AP parameters is the size of all the AP parameters and is in units of, for example, bytes.

The network ID is an identifier for identifying the DNN to which the input tensor is input. The identifier flag indicates whether the tensor to which the header is added is any one of an input tensor and an output tensor.

The CPU 216 sets the above-described validity flag, frame count, maximum line length, size of AP parameters, and identifier flag. In addition, the application processor 120 sets the network ID.

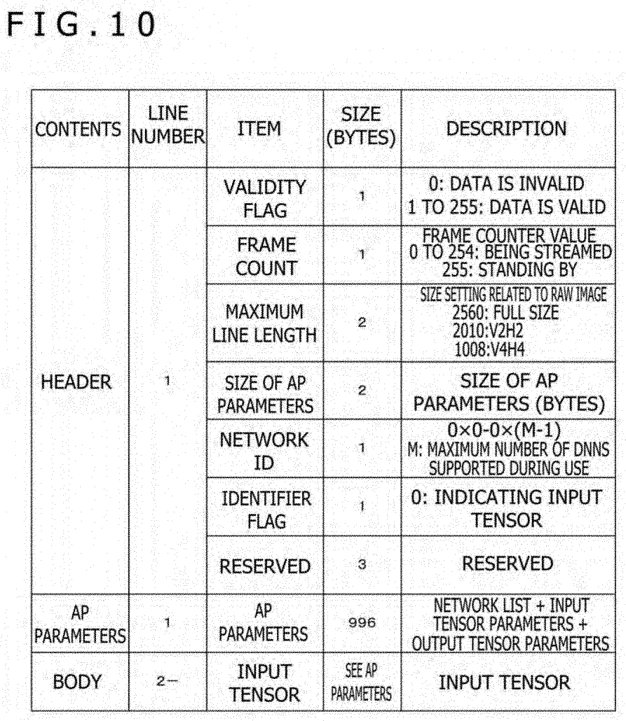

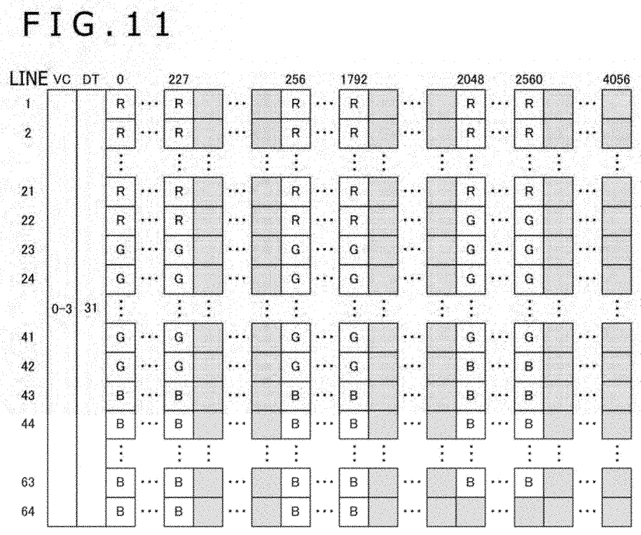

FIG. 10 is a diagram illustrating details of metadata corresponding to the input tensor according to the embodiment of the present technology. A line with line number “1” contains a header and AP parameters. Lines with line number “2” and the subsequent line numbers correspond to a body area and store an input tensor.

The validity flag is assigned one byte. The validity flag being “0” indicates that the data is invalid. The validity flag with a value ranging from “1” to “255” indicates that the data is valid.

The frame count is assigned one byte. While a plurality of RAW images is continuously being captured (in other words, during streaming), the value is counted from “0” to “244.” During standby when the streaming is stopped, the frame count is set to “255.”

The maximum line length is assigned two bytes. In a case where the RAW image has a full size, the maximum line length is set to “2560.” In a case where the RAW image has a V2H2 size smaller than the full size, the maximum line length is set to “2010.” In a case where the RAW image has a V4H4 size smaller than the V2H2 size, the maximum line length is set to “1008.”

The size of AP parameters is assigned two bytes. The size is in units of bytes.

The network ID is assigned one byte. The network ID is set to a hexadecimal number ranging from “0” to “M−1.” M is the maximum number of DNNs supported during use.

The identifier flag is assigned one byte. The identifier flag of “0” indicates that the tensor with the header added thereto is an input tensor.

The reserved is assigned three bytes.

The AP parameters are assigned 996 bytes. The AP parameters include a network list, input tensor parameters, and output tensor parameters. Details of the AP parameters will be described below.

FIG. 11 is a diagram depicting a configuration example of the input tensor according to the embodiment of the present technology. Areas R (red), G (green), and B (Blue) in FIG. 11 respectively indicate areas in which red, green, and blue pixel data are stored. Gray areas indicate padding areas. The 0th to 227th columns and the 256th to 1792nd columns each include an array of 64 lines of pixel data. The 2048th to 2560th columns each include an array of 63 lines of pixel data. These arrays constitute a 227×227×3 input tensor.

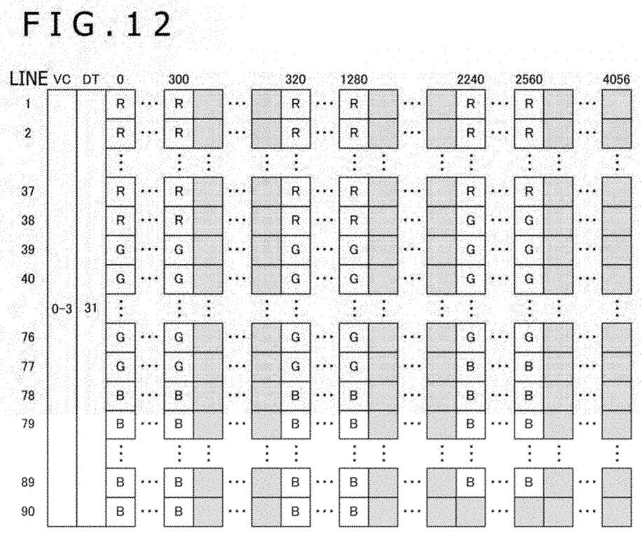

FIG. 12 is a diagram depicting another example of the input tensor according to the embodiment of the present technology. The 0th to 300th columns and the 320th to 1280th columns each include an array of 90 lines of pixel data. The 2240th to 2560th columns include an array of 89 lines of pixel data. These arrays constitute a 300×300×3 input tensor.

As illustrated in FIG. 11 and FIG. 12, the input tensor has a format different from a general image format in order to allow efficient use of the memory (SRAM 215). Thus, decoding the input tensor requires the AP parameters.

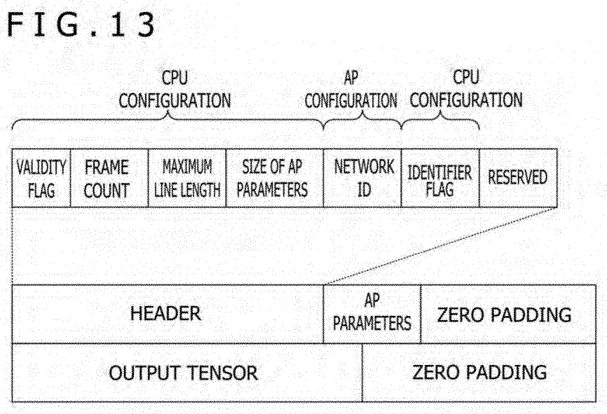

FIG. 13 is an example of a data format of metadata including an output tensor according to the embodiment of the present technology. The metadata includes a header, AP parameters, and an output tensor. The header has a configuration similar to that illustrated in FIG. 9.

In a case of outputting both input tensor and output tensor, the image sensor 200 outputs, as metadata, both data illustrated in FIG. 9 and data illustrated in FIG. 13. That is, the header is added to each of the input tensor and the output tensor. In a case where only the output tensor is output, the image sensor 200 outputs the metadata illustrated in FIG. 13.

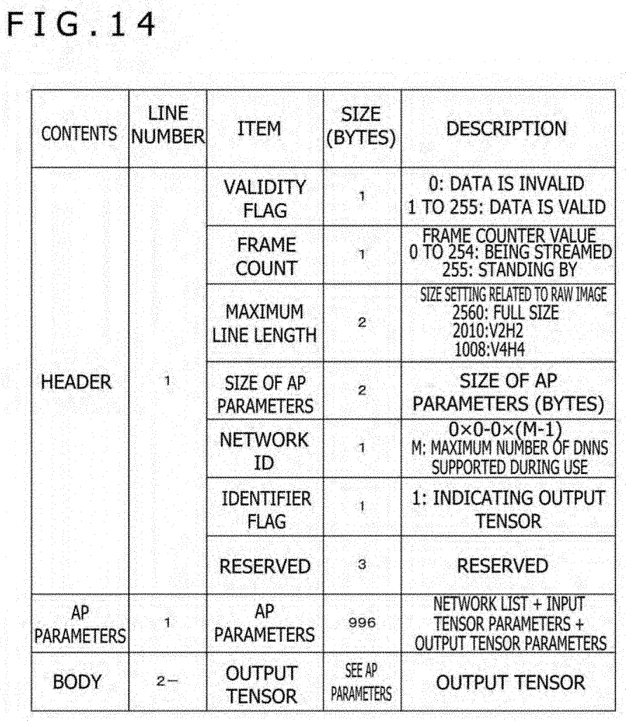

FIG. 14 is a diagram illustrating details of the metadata corresponding to the output tensor according to the embodiment of the present technology. The identifier flag is set to a value of “1” indicating that the tensor with the header added thereto is an output tensor.

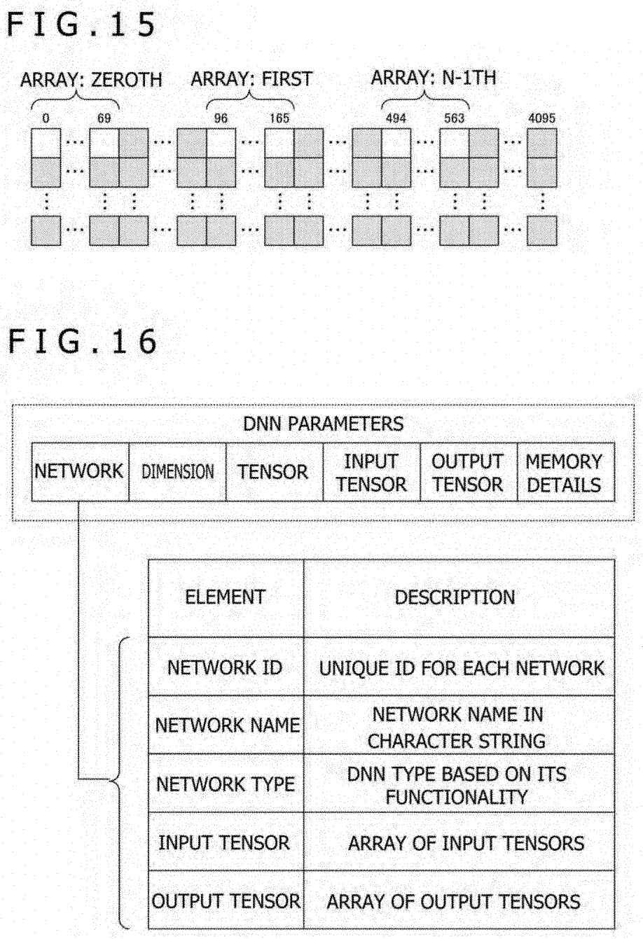

FIG. 15 is a diagram depicting a configuration example of the output tensor according to the embodiment of the present technology. In FIG. 15, white areas indicate areas in which elements are stored. Gray areas indicate padding areas. When the dimension of the output tensor is represented as N, the 0th array includes 70 elements stored at the 0th to 69th addresses. The 1st array is stored at the 96th to 165th addresses. The N-lth array is stored at the 494th to 563rd addresses. As illustrated in FIG. 15, each array is serialized, and the serialized array is written into the SRAM 215.

In addition, as illustrated in FIG. 15, the output tensor has a format different from a general format in order to allow efficient use of the memory (SRAM 215). Thus, decoding the output tensor requires the AP parameters.

FIG. 16 is a diagram depicting an example of data associated with the network in DNN parameters according to the embodiment of the present technology. The DNN parameters include, for each DNN, parameters related to the network, the dimension, the tensor, the input tensor, the output tensor, and the memory details.

The data related to the network include elements “network ID,” “network name,” “network type,” “input tensor,” and “output tensor.”

As the “network ID,” a unique identifier is described for each network (DNN). As the network name, the name of the network is described as a string of characters. As the “network type,” the type of the DNN is described on the basis of the functionality thereof. As the “input tensor,” an input tensor array input to the DNN is described. As the “output tensor,” an output tensor array output from the DNN is described.

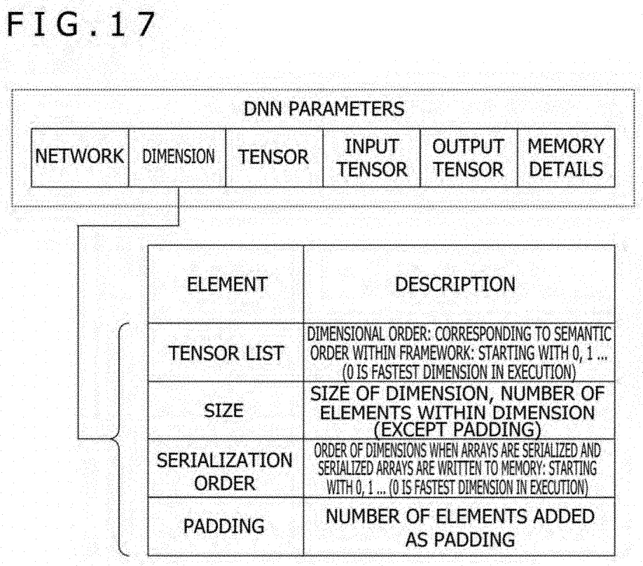

FIG. 17 is a diagram depicting an example of data associated with the dimension in the DNN parameters according to the embodiment of the present technology. The data associated with the dimension include elements of a “tensor list,” “size,” “serialization order,” and “padding.”

As the “tensor list,” a dimension order is described. The dimension order corresponds to a sematic order in a framework. The dimension order starts with 0, and 0 is the fastest order in execution. As the “size,” the size of the dimension or the number of elements within the dimension is described. However, padding is excluded. As the “serialization order,” the order of dimensions written into the memory after serialization is described. The serialization order starts with 0, and 0 is the fastest dimension in execution. As an element of the “padding,” the number of elements added as padding is described.

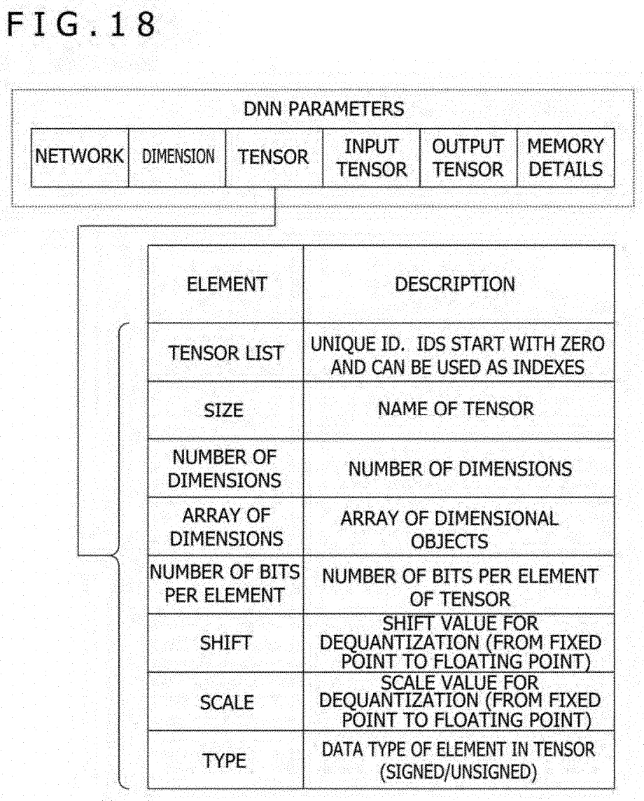

FIG. 18 is a diagram depicting an example of data associated with the tensor in the DNN parameters according to the embodiment of the present technology. The data associated with the tensor includes elements of a “tensor list,” a “name,” the “number of dimensions,” an “array of dimensions,” the “number of bits per element,” “shift,” “scale,” and “type.”

As the “tensor list,” a unique identifier is described. The identifier starts with zero, and can thus be used as an index. As the “name,” the name of the tensor is described. As the “array of dimensions,” an array of dimensional objects is described. As the “number of bits per element,” the number of bits per element of the tensor is described. As an element of the “shift,” a shift value for dequantization from fixed point to floating point is described. As an element of the “scale,” a scale value for dequantization from fixed point to floating point is described. As the “type,” whether the data type of an element in the tensor is signed or unsigned is described.

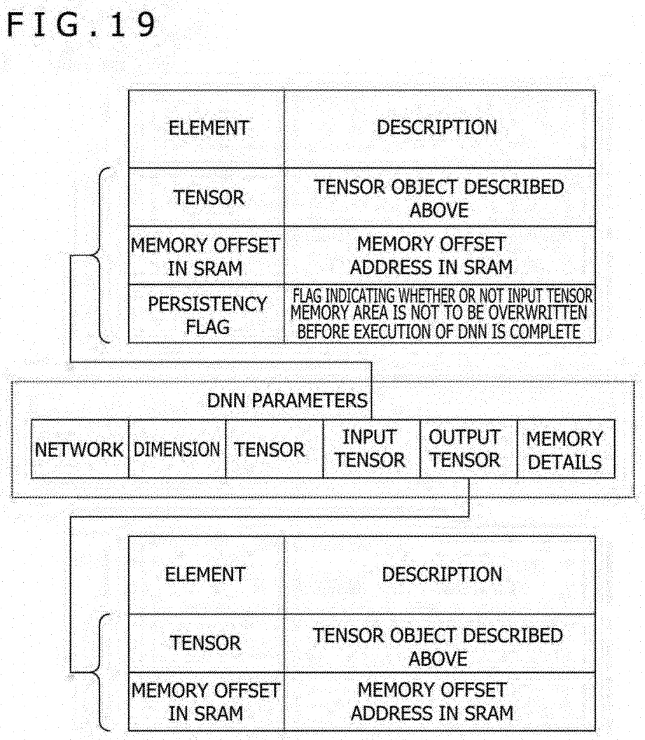

FIG. 19 is a diagram depicting an example of data associated with the input tensor and the output tensor in the DNN parameters according to the embodiment of the present technology. The data associated with the input tensor include elements of a “tensor,” “offset in the SRAM,” and a “persistency flag.”

As an element of the “tensor,” the above-described tensor object is described. As the “offset in the SRAM,” a memory offset address in the SRAM 215 is described. As the “persistency flag,” a flag that indicates whether or not an input tensor memory area is not to be overwritten before execution of the DNN is complete” is described. The input tensor memory area indicates an area in the SRAM 215 to which the input tensor is written. In a case where the input tensor memory area is not to be overwritten, the persistency flag is set to “0.” In a case where the input tensor memory area is to be overwritten, the persistency flag is set to “1.”

Normally, the persistency flag is set to “0.” However, in a case where execution of the DNN takes much time and does not end within the period of a vertical synchronizing signal, the persistency flag is set to “1.” The case where the persistency flag is set to “1” will be described below in the modification.

In addition, the data associated with the output tensor includes elements of the “tensor” and the “offset in the SRAM.”

As an element of the “tensor,” the above-described tensor object is described. In addition, as the “offset in the SRAM,” the memory offset address in the SRAM 215 is described.

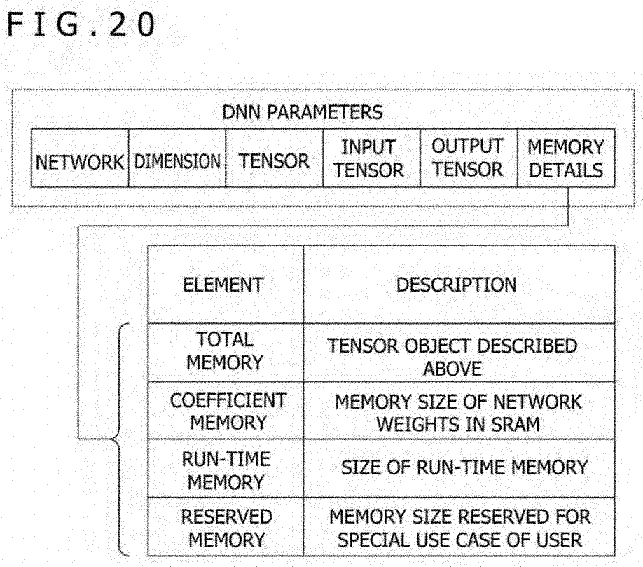

FIG. 20 is a diagram depicting an example of data associated with the memory details in the DNN parameters according to the embodiment of the present technology. The data related to the memory details includes elements of “total memory,” “coefficient memory,” “run-time memory,” and “reserved memory.”

As an element of the “total memory,” the size of the memory into which the above-described tensor object is written is described. As an element of the “coefficient memory,” the size of the memory in the SRAM 215 into which network weights are written is described. As an element of the “run-time memory,” the size of the run-time memory is described. As an element of the “reserved memory,” the size of the memory reserved for a special use case of the user is described.

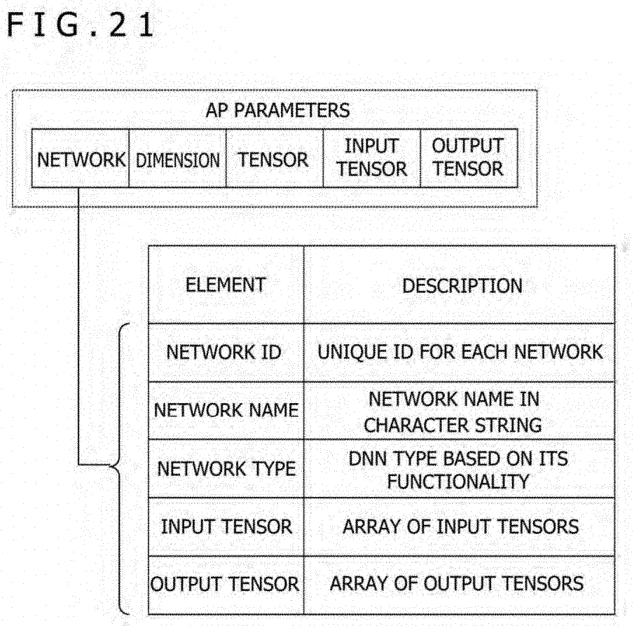

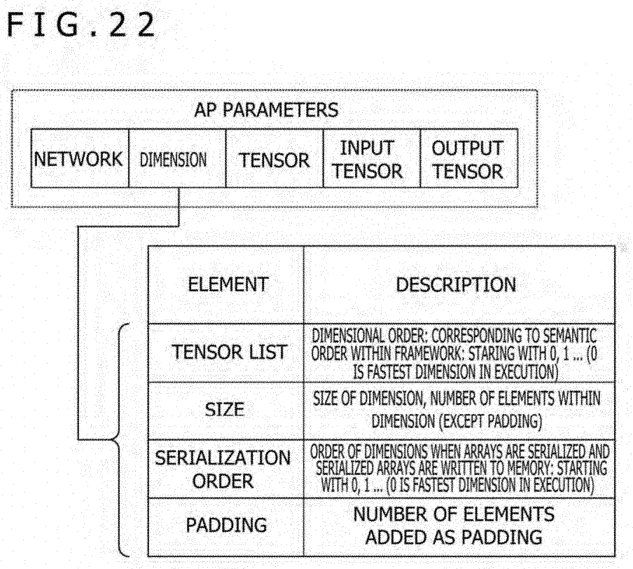

FIG. 21 is a diagram depicting an example of data associated with the network in the AP parameters according to the embodiment of the present technology. As is the case with the DNN parameters, the data in the AP parameters includes elements of the “network ID,” the “network name,” the “network type,” the “input tensor,” and the “output tensor.”

FIG. 22 is a diagram depicting an example of data associated with the dimension in the AP parameters according to the embodiment of the present technology. As is the case with the DNN parameters, the data associated with the dimension in the AP parameters include elements of the “tensor list,” the “size,” the “serialization order,” and the “padding.” Unlike in the DNN parameters, in the AP parameters, the data related to the memory details is unnecessary for the application processor 120 and is thus not described.

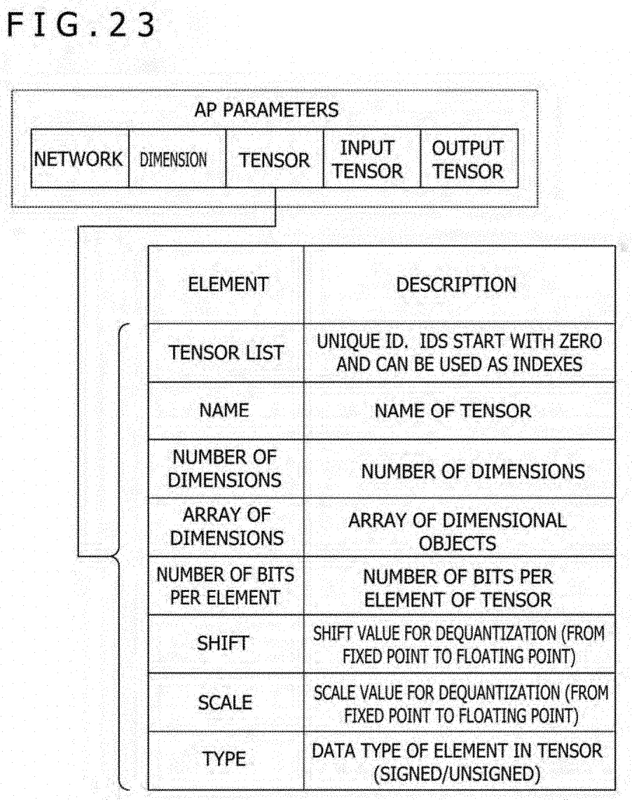

FIG. 23 is a diagram depicting an example of data in the AP parameters associated with the tensor according to the embodiment of the present technology. As is the case with the DNN parameters, the data associated with the tensor in the AP parameters includes elements of the “tensor list,” the “name,” the “number of dimensions,” the “array of dimensions,” the “number of bits per element, the “shift,” the “scale”, and the “type.”

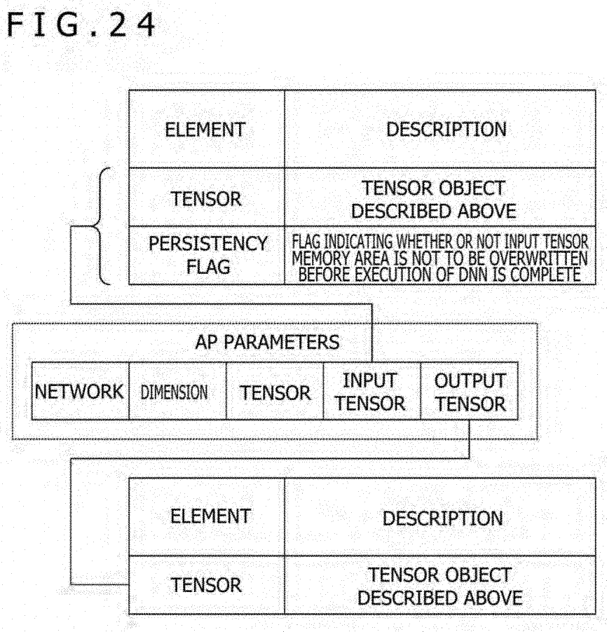

FIG. 24 is a diagram depicting an example of data associated with the input tensor and the output tensor in the AP parameters according to the embodiment of the present technology. The data associated with the input tensor includes elements of the “tensor” and the “persistency flag.” In addition, the data associated with the output tensor includes an element of the “tensor.” Unlike in the DNN parameters, in the AP parameters, the offset address is unnecessary data for the application processor 120 and is thus not described.

As illustrated in FIGS. 16 to 24, that part of the data in the DNN parameters, which is required for the application processor 120, is used as the AP parameters. In other words, the AP parameters correspond to a subset of the DNN parameters.

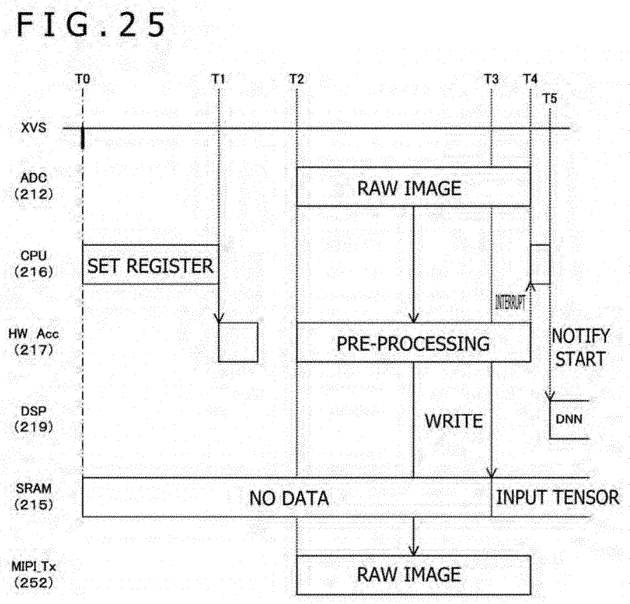

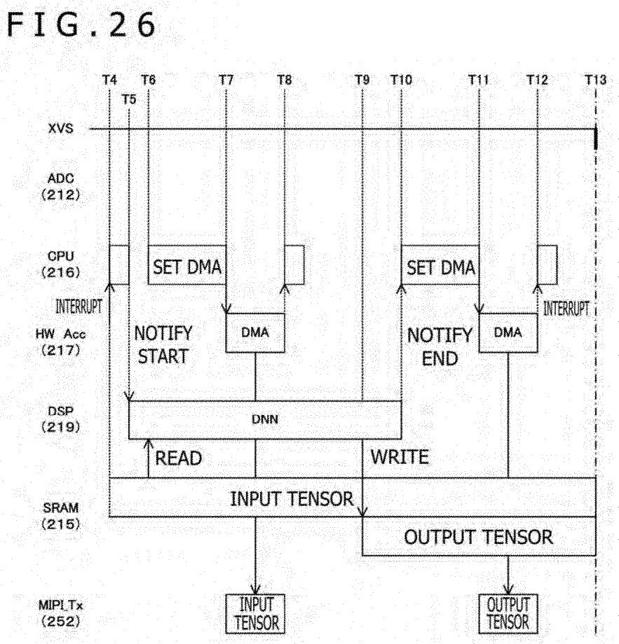

FIG. 25 is a timing chart depicting an example of operation of the image sensor 200 to output of a RAW image according to the embodiment of the present technology. The operation is started, for example, when a predetermined application for the image recognition is executed. In FIG. 25 and the subsequent figures, “ADC” denotes an ADC in the analog-digital conversion section 212. “HW Acc” denotes the hardware accelerator 217. “DSP” denotes the digital signal processing section 219.

A vertical synchronizing signal XVS is assumed to fall at timing TO. During a period of time from timing TO to timing T1, the CPU 216 selects one of M DNNs to be executed and sets the selected DNN in the register.

During a period of time from timing T2 to timing T4, the analog-digital conversion section 212 generates a RAW image by AD conversion. The image signal processing section 214 (not depicted) and the hardware accelerator 217 execute various types of image processing operations on the RAW image as preprocessing to generate an input tensor. In addition, the RAW image is output from the output interface 252 during a period of time from timing T2 to timing 14. At timing T3, an input tensor starts to be written into the SRAM 215. Processing at timing 14 and subsequent timings will be described below.

FIG. 26 is a timing chart depicting an example of operation of the image sensor 200 to output of an output tensor according to the embodiment of the present technology. At timing 14 at which preprocessing is complete, the hardware accelerator 217 supplies an interrupt signal to the CPU 216.

At timing T5, the CPU 216 notifies the digital signal processing section 219 of the start of the image recognition processing. During a period of time from timing T5 to timing T10, the digital signal processing section 219 reads out the input tensor from the SRAM 215 and executes the image recognition processing on the input tensor by use of the DNN. At this time, the digital signal processing section 219 also reads out the network weight, the DNN program code, and the DNN parameters from the SRAM 215.

In addition, during a period of time from timing T6 to timing T7, the CPU 216 make settings for DMA (Direct Memory Access) transfer. During a period of time from timing T7 to timing T8, a DMA controller (not depicted) performs DMA transfer of the input tensor from the SRAM 215 to the output interface 252.

In addition, the digital signal processing section 219 writes back the output tensor to the SRAM 215 at timing T9, and notifies the CPU 216 of the end of the image recognition processing at timing T10.

During a period of time from timing T10 to timing T11, the CPU 216 makes settings for DMA transfer. During a period of time from timing T11 to timing T12, according to the settings, the DMA controller performs DMA transfer of the output tensor from the SRAM 215 to the output interface 252.

At timing T13, the vertical synchronizing signal XVS falls. After timing T13 and subsequent timings, similar processing is repeated synchronously with the vertical synchronizing signal XVS. A period of time from timing T0 to timing T13 (in other words, the period of the vertical synchronizing signal XVS) is hereinafter referred to as the “frame period.”

As illustrated in FIGS. 25 and 26, the image recognition processing by the DNN is complete within one frame period (period of vertical synchronizing signal XVS). Then, during the frame period when a RAW image and an input tensor are output, an output tensor corresponding to the input tensor is output.

Thus, according to the embodiment of the present technology, the output interface 252 outputs the AP parameters for decoding and the output tensor, and thus despite switching to a DNN with a different output format, the succeeding circuit can decode the output tensor. This allows the digital signal processing section 219 to use DNNs with different output formats, improving the versatility of the information processing system.

### <2. First Modification>

In the above-described embodiment, the digital signal processing section 219 uses a single DNN to execute the image recognition processing during streaming, and switches the DNN while the streaming is stopped. However, the use of a single DNN may lead to insufficient versatility and convenience of the information processing system. For example, recognition of a plurality of objects may require a plurality of DNNs with different algorithms, leading to the single DNN having difficulty in dealing with the processing. The image sensor 200 according to a first modification of the embodiment is different from that according to the embodiment in that the DNN is switched during streaming.

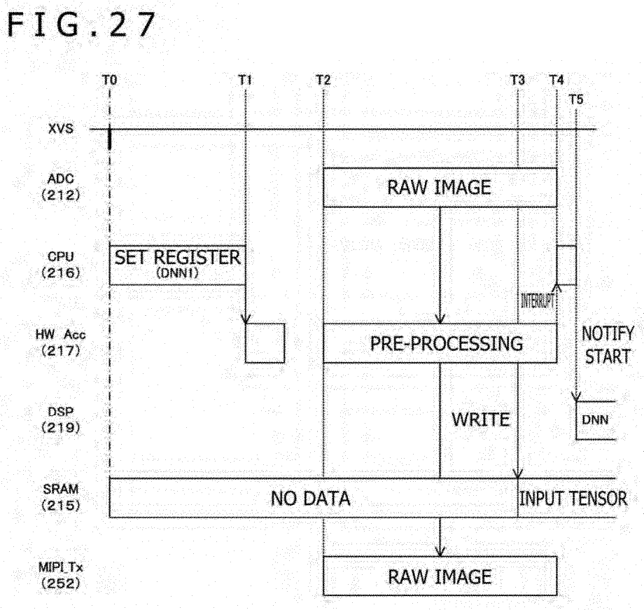

FIG. 27 is a timing chart depicting an example of operation of the image sensor 200 to output of the first RAW image according to the first modification of the embodiment of the present technology. In the first modification of the embodiment, the digital signal processing section 219 is assumed to be able to execute two DNNs, DNN1 and DNN2.

During a period of time from timing T0 to timing T1, the CPU 216 selects and sets DNN1 in the register. Then, during a period of time from timing T2 to timing T4, the analog-digital conversion section 212 generates the first RAW image by AD conversion.

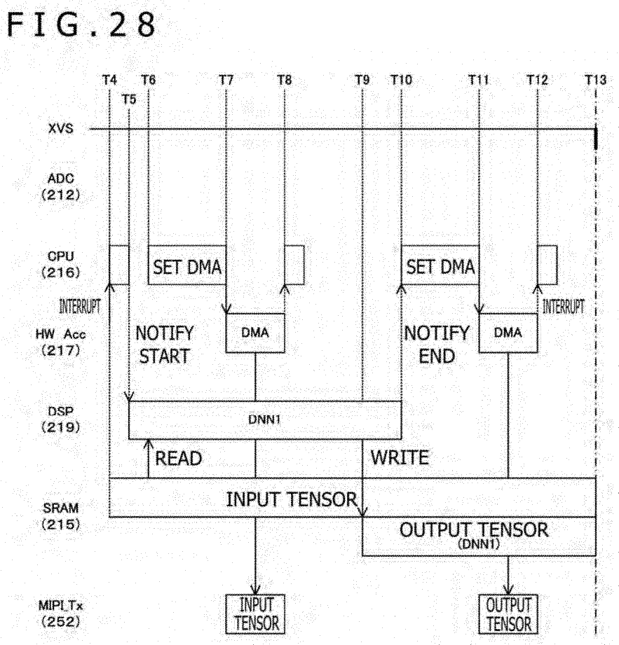

FIG. 28 is a timing chart depicting an example of operation of the image sensor to output of the output tensor corresponding to the first RAW image according to the first modification of the embodiment of the present technology.

During a period of time from timing T5 to timing T10, the digital signal processing section 219 reads out the first input tensor from the SRAM 215, and executes the image recognition processing on the input tensor by use of DNN1. In addition, at timing T9, the digital signal processing section 219 writes back to the SRAM 215 the output tensor corresponding to DNN1.

A header including the network ID indicating DNN1 is added to each of the input tensor and output tensor corresponding to DNN1.

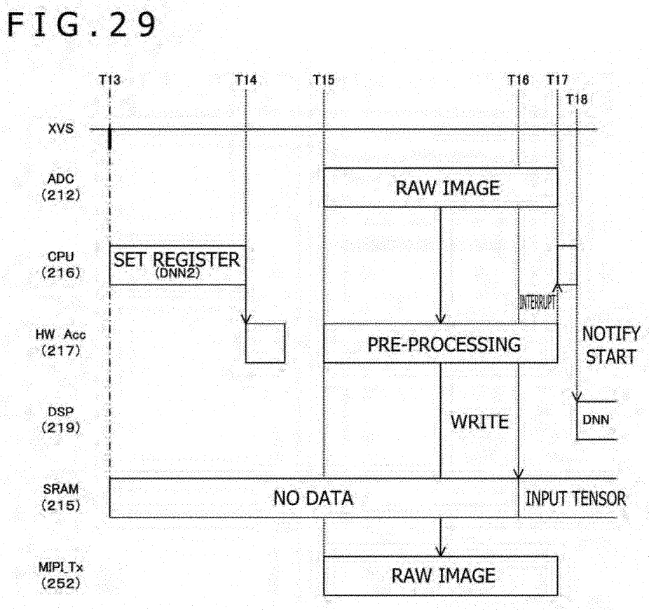

FIG. 29 is a timing chart depicting an example of operation of the image sensor 200 to output of the second RAW image according to the first modification of the embodiment of the present technology.

During a period of time from timing T13 to timing 114, the CPU 216 selects and sets DNN2 in the register. Then, during a period of time from timing T15 to timing T17, the analog-digital conversion section 212 generates the second RAW image by AD conversion.

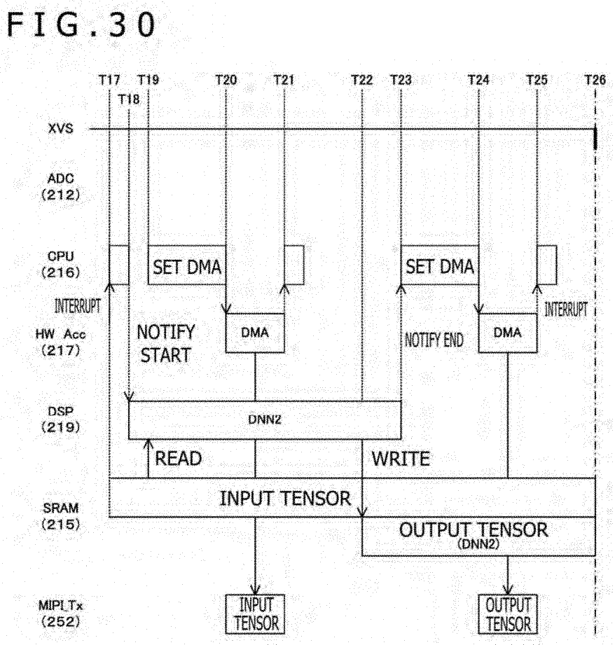

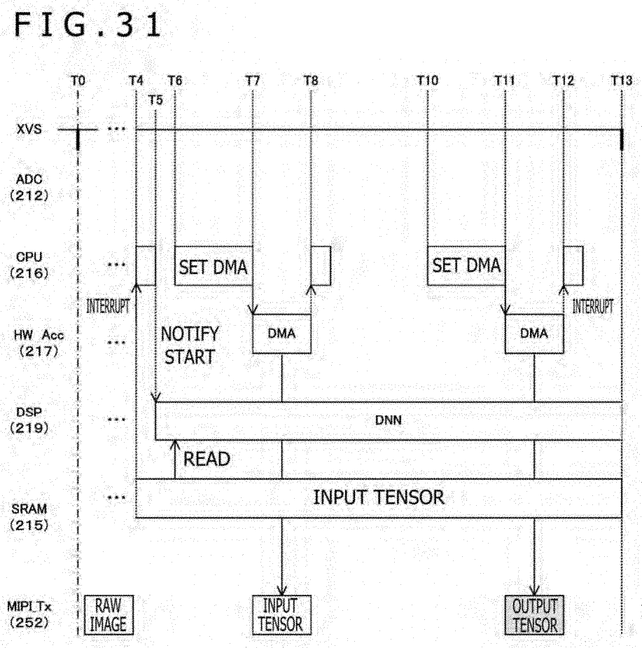

FIG. 30 is a timing chart depicting an example of operation of the image sensor to output of the output tensor corresponding to the second RAW image according to the first modification of the embodiment of the present technology.

During a period of time from timing T18 to timing T25, the digital signal processing section 219 reads out the second input tensor from the SRAM 215, and executes the image recognition processing on the input tensor by use of DNN2. In addition, at timing T22, the digital signal processing section 219 writes back to the SRAM 215 the output tensor corresponding to DNN2.

A header including the network ID indicating DNN2 is added to each of the input tensor and output tensor corresponding to DNN2.

As illustrated in FIGS. 27 to 30, the image sensor 200 executes DNN1 during the first frame period, and executes DNN2 during the next frame period. The image sensor 200 subsequently executes similar processing.

Thus, DNN1 and DNN2 are alternately executed with a period of two frames. Note that the image sensor 200 can also sequentially execute three or more, M DNNs on a one-by-one basis with a period of M frames. Execution of the plurality of DNNs improves the versatility and convenience of the system, compared to the case of use of a single DNN.

As described above, according to the first modification of the embodiment of the present technology, the digital signal processing section 219 sequentially executes a plurality of DNNS on a one-by-one basis during streaming, and can thus improve the versatility and convenience of the system, compared to the case of execution of a single DNN.

### <3. Second Modification>

In the above-described embodiment, the digital signal processing section 219 completes, within one frame period (that is, the period of the vertical synchronizing signal), the image recognition processing executed by the DNN. However, the execution time of the image recognition processing varies with the algorithm of the DNN, possibly leading to a failure to complete the processing within one frame period. The image sensor 200 according to the second modification of the embodiment differs from that according to the embodiment in that, after the elapse of the frame period when an input tensor is generated, an output tensor corresponding to the input tensor is output.

FIG. 31 is a timing chart depicting an example of operation of the image sensor until output of the first input tensor according to the second modification of the embodiment of the present technology. During a period of time until timing T4, the first RAW image is output.

At timing T5, the digital signal processing section 219 starts the image recognition processing for the first input tensor. The image recognition processing is assumed not to be complete within the first frame period.

In addition, during a period of time from timing T7 to timing T8, the DMA controller (not depicted) performs DMA transfer of the first input tensor from the SRAM 215 to the output interface 252 according to the settings in the register. The header added to the input tensor includes a validity flag set to a value other than “0,” a persistency flag set to “1,” and a frame counter with a value corresponding to the first input tensor (for example, “0”).

In addition, during a period of time from timing T11 to timing T12, the DMA controller performs DMA transfer of an invalid output tensor from the SRAM 215 to the output interface 252 according to the settings in the register. The header included in this output tensor includes a validity flag set to “0.”

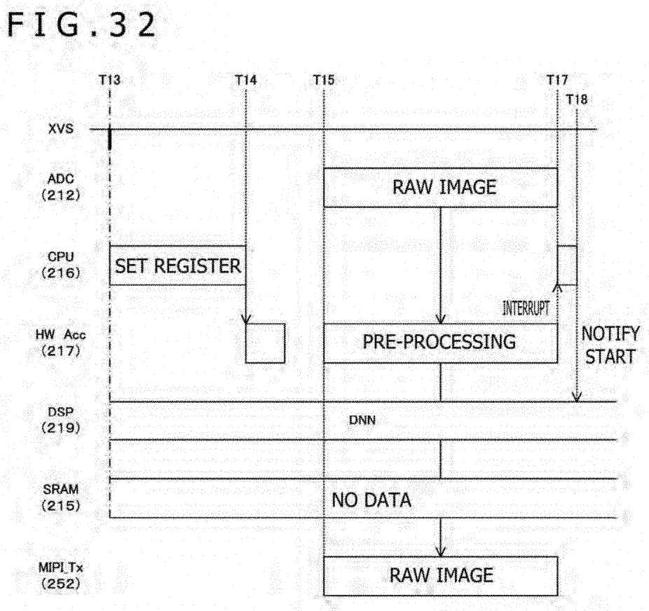

FIG. 32 is a timing chart depicting an example of operation of the image sensor to output of the second RAW image according to the second modification of the embodiment of the present technology. During a period of time from timing T15 to timing T17, the analog-digital conversion section 212 generates the second RAW image by AD conversion. At this point of time, the second input tensor resulting from the preprocessing is not written into the SRAM 215.

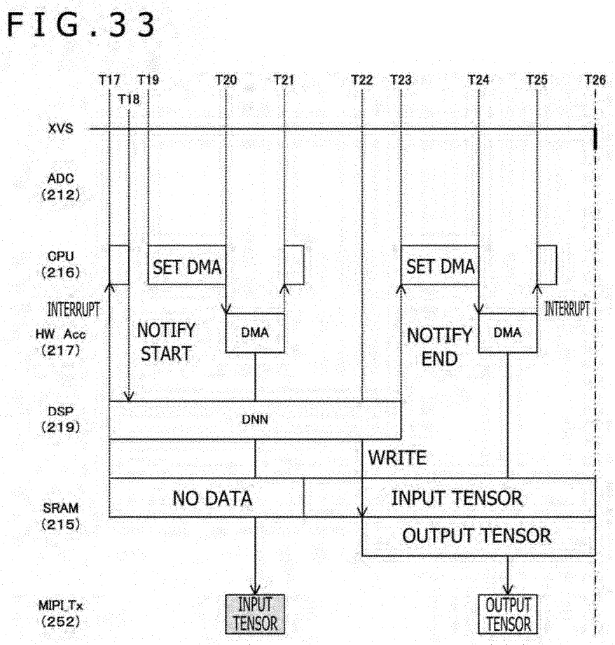

FIG. 33 is a timing chart depicting an example of operation of the image sensor to output of the output tensor corresponding to the first RAW image according to the second modification of the embodiment of the present technology. The digital signal processing section 219 deletes the first input tensor from the SRAM 215.

During a period of time from timing T20 to timing T21, the DMA controller (not depicted) performs DMA transfer of an invalid input tensor from the SRAM 215 to the output interface 252 according to the settings in the register. The header included in this input tensor includes a validity flag set to “0.” Immediately after this timing T21, the input tensor memory area of the SRAM 215 is overwritten with the second input tensor. That is, the input tensor memory area is overwritten before the execution of the DNN is complete.

In addition, the digital signal processing section 219 writes back the output tensor to the SRAM 215 at timing T22, and notifies the CPU 216 of the end of the image recognition processing at timing T23. Then, during a period of time from timing T24 to timing T25, the DMA controller performs DMA transfer of the output tensor from the SRAM 215 to the output interface 252 according to the settings in the register. The header added to the output tensor includes a validity flag set to a value other than “0” and a frame counter with a value corresponding to the first output tensor (for example, “0”.

As illustrated in FIGS. 31 to 33, the DNN may fail to be complete within one frame. In this case, only the RAW image and the input tensor are output during the frame period in which the execution of the DNN is started, and the output tensor is output after the frame period elapses (for example, in the next frame). Note that, in a case where two or more frame periods are required for the DNN to be complete, the image sensor 200 can also output the output tensor after timing T26.

Since the header includes the persistency flag, the application processor 120 can recognize, with reference to the flag, that the frame in which the input tensor is output is different from the frame in which the output tensor is output.

Note that, in a case where no case is assumed in which the DNN is not complete within the frame period, the persistency flag can be removed from the header.

In addition, since the headers of the input tensor and the output tensor each include the validity flag, the system can be prevented from malfunctioning by invalidating the output tensor during the first frame period and the input tensor during the next frame period.

Note that, in a case where no case is assumed in which the DNN is not complete within the frame period, the persistency flag can be removed from the header.

In addition, the frame count in the header of the input tensor is set the same as that in the header of the output tensor corresponding to the input tensor. Thus, even in a case where the DNN is not complete within the frame period, the application processor 120 can identify the input tensor corresponding to the output tensor with reference to the frame count.

Note that, in a case where no case is assumed in which the DNN is not complete within the frame period, the frame count can be removed from the header. In addition, even in a case where the DNN is not complete within the frame period, the frame count can be removed from the header in a case where the application processor 120 can estimate the timing when the DNN is complete.

As described above, the header includes the persistency flag, the validity flag, and the frame count, and thus with reference to the flags and the frame count, the application processor 120 can deal with the case in which the DNN is not complete within one frame period.

Thus, according to the second modification of the present technology, the header contains the persistency flag, the validity flag, and the persistency flag, and thus, the information processing system can deal with the case in which the DNN is not complete within one frame period.

### <4. Third Modification>

In the second modification of the above-described embodiment, the digital signal processing section 219 continuously executes the DNN while the RAW image (frame) is held in the SRAM 215 (in other words, during capture). However, in this configuration, memory access may result from the execution of the DNN during capture and may lead to generation of band noise. The image sensor 200 according to the third modification of the embodiment is different from that according to the second modification in that the execution of the DNN is suspended during capture.

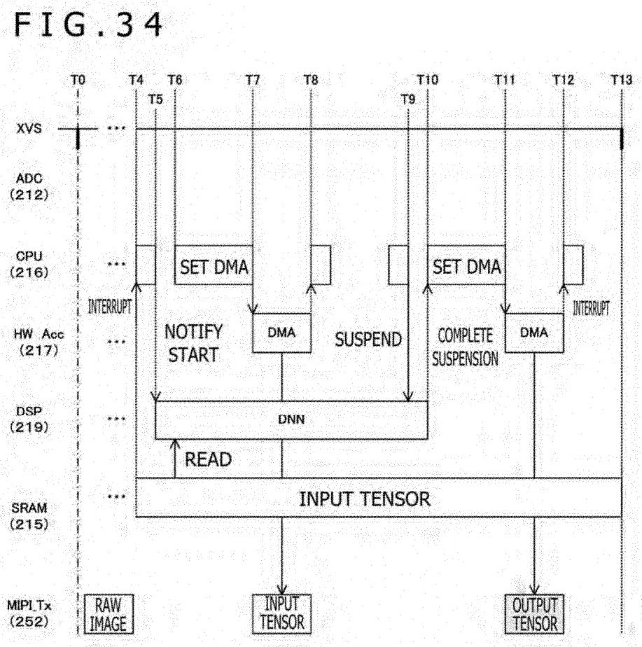

FIG. 34 is a timing chart depicting an example of operation of the image sensor to output of the first input tensor according to the third modification of the embodiment of the present technology.

During a period of time from timing T5 to timing T10, the digital signal processing section 219 reads out the input tensor from the SRAM 215 and executes the image recognition processing on the input tensor by use of the DNN. At timing T9, the CPU 216 instructs the digital signal processing section 219 to suspend the image recognition processing. At timing T10, the digital signal processing section 219 suspends the image recognition processing, and notifies the CPU 216 of completion of the suspension.

In addition, during a period of time from timing T7 to timing T8, the DMA controller (not depicted) performs DMA transfer of the first input tensor from the SRAM 215 to the output interface 252 according to the settings in the register. The header added to the input tensor includes a validity flag set to a value other than “0,” a persistency flag set to a value of “1,” and a frame counter with a value corresponding to the first input tensor (for example, “0”).

Then, during a period of time from timing T10 to timing T11, the CPU 216 makes settings for DMA transfer. During a period of time from timing T11 to timing T12, according to the settings, the DMA controller performs DMA transfer of an invalid output tensor from the SRAM 215 to the output interface 252. The header included in the output tensor includes a validity flag set to “0.”

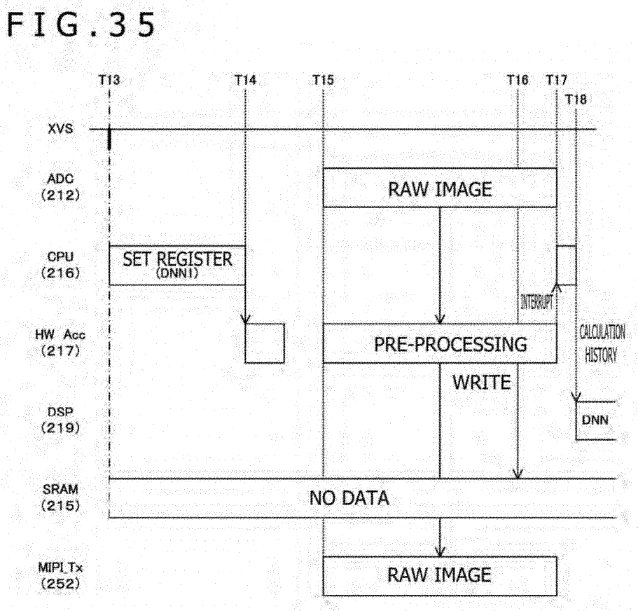

FIG. 35 is a timing chart depicting an example of operation of the image sensor to output of the second RAW image according to the third modification of the embodiment of the present technology.

During a period of time from timing T15 to timing T17, the analog-digital conversion section 212 generates a RAW image by AD conversion. The image signal processing section 214 (not depicted) and the hardware accelerator 217 execute various types of image processing on the second RAW image as preprocessing to generate the second input tensor. In the preprocessing, the image signal processing section 214 temporarily holds (captures) the RAW image in the SRAM 215. The period of time from timing T15 to timing T17 is referred to as a capture period. During the capture period, the image recognition processing executed by the DNN is suspended, thus suppressing possible band noise. Note that at this point of time, the second input tensor resulting from the preprocessing is not written to the SRAM 215.

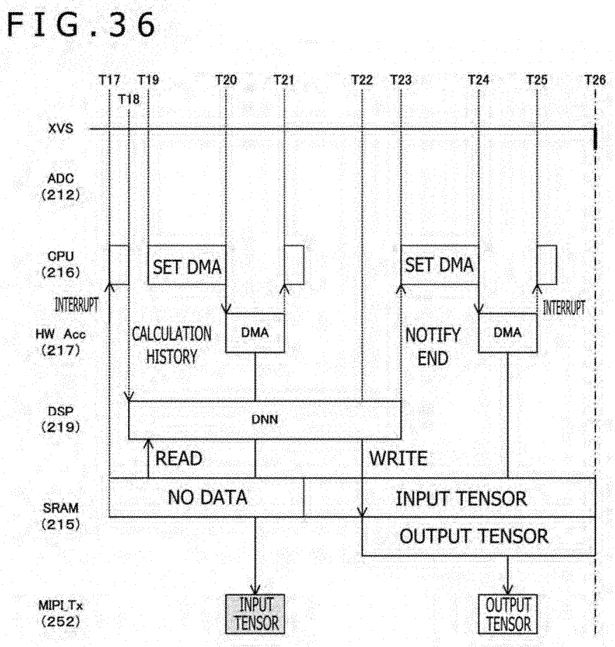

FIG. 36 is a timing chart depicting an example of operation of the image sensor to output of the output tensor corresponding to the first RAW image according to the third modification of the embodiment of the present technology.

At timing T18 after the capture period elapses, the CPU 216 supplies the digital signal processing section 219 with calculation history to the suspension, and indicates to the digital signal processing section 219 to resume the image recognition processing. The digital signal processing section 219 resumes the image recognition processing, and at timing T22, writes back to the SRAM 215 the output tensor corresponding to the DNN2.

In addition, during a period of time from timing T20 to timing T21, according to the settings in the register, the DMA controller (not depicted) performs DMA transfer of an invalid input tensor from the SRAM 215 to the output interface 252. The header included in the input tensor includes a validity flag set to “0.” Immediately after timing T21, the input tensor memory area of the SRAM 215 is overwritten with the second input tensor. That is, the input tensor memory area is overwritten before the execution of the DNN is complete.

Then, during a period of time from timing T24 to timing T25, according to the settings, the DMA controller performs DMA transfer of the output tensor from the SRAM 215 to the output interface 252. The header added to the output tensor includes a validity flag set to a value other than “0” and a frame counter with a value corresponding to the first output tensor (for example, “0”).

As illustrated in FIGS. 34 to 36, the digital signal processing section 219 suspends the image recognition processing before the capture period in which the frame is held in the SRAM 215 begins, and resumes the image recognition processing after the capture period elapses. This prevents memory access resulting from the execution of the DNN during capture, allowing possible band noise caused by the memory access to be suppressed.

Note that the first modification of the embodiment can also be applied to the second or third modification of the embodiment. In this case, for example, DNN1 is executed in two of the four frames constituting the period, and DNN2 is executed in the remaining two frames.

Thus, according to the third modification of the present technology, the digital signal processing section 219 suspends the image recognition processing before the capture period begins, and resumes the image recognition processing after the capture period elapses. This prevents memory access resulting from the execution of the DNN during capture. Accordingly, during capture, possible band noise caused by the memory access can be suppressed.

Note that the above-described embodiments illustrate an example for implementing the present technology and that each of the elements of the embodiments has a correspondence relation with a respective one of the specific elements of the invention in the claims. Similarly, each of the specific elements of the invention in the claims has a correspondence relation with a respective one of the elements with the same names in the embodiments of the present technology. However, the present technology is not limited to the embodiments and may be implemented by making modifications to the embodiments without departing from the spirits of the present technology.

Note that the effects described herein are only illustrative and not restrictive and that the present technology may have any other effect.

Note that the present technology can also be configured as follows.

(1)

A solid-state imaging element including:

a processing section configured to select any one of a plurality of DNNs (Deep Neural Networks) with different formats of an output tensor;

a digital signal processing section configured to execute image recognition processing on an input tensor by use of the selected DNN to generate the output tensor; and

an output interface configured to output a decode parameter for decoding the generated output tensor and the output tensor.

(2)

The solid-state imaging element according to (1) described above, further including:

an input interface configured to receive, as a DNN parameter, a parameter for causing the digital signal processing section to execute each of the plurality of DNNs, in which

the digital signal processing section executes the image recognition processing on the basis of the DNN parameter.

(3)

The solid-state imaging element according to (1) or (2) described above, in which

the output interface further outputs the input tensor.

(4)

The solid-state imaging element according to (3) described above, further including:

a memory configured to store the input tensor in a predetermined area, in which

the output interface outputs the input tensor read out from the memory, and

the decode parameter includes a persistency flag indicating whether or not the area is not to be overwritten before the image recognition processing is complete.

(5)

The solid-state imaging element according to (3) or (4) described above, in which

the output interface outputs the input tensor and the output tensor to each of which a header is added.

(6)

The solid-state imaging element according to (5) described above, in which

the header added to the input tensor includes a validity flag indicating whether or not the input tensor is valid, and

the header added to the output tensor includes a validity flag indicating whether or not the output tensor is valid.

(7)

The solid-state imaging element according to (5) or (6), in which

the header added to the input tensor and the header added to the output tensor corresponding to the input tensor include a frame count of the same value.

(8)

The solid-state imaging element according to any one of (1) to (7) described above, in which

the input tensor includes a first input tensor and a second input tensor,

the plurality of DNNs includes a first DNN and a second DNN, and

the digital signal processing section uses the first DNN for the first input tensor and uses the second DNN for the second input tensor.

(9)

The solid-state imaging element according to any one of (1) to (8) described above, in which

the digital signal processing section executes image recognition processing on the input tensor to generate the output tensor, and

the output interface outputs the output tensor after a predetermined frame period elapses in which the input tensor is generated.

(10)

The solid-state imaging element according to (9) described above, in which

the digital signal processing section suspends the image recognition processing before a capture period in which a frame is held in the memory begins, and resumes the image recognition processing after the capture period elapses.

(11)

Metadata Including:

an output tensor generated by image recognition processing executed on an input tensor; and

a decode parameter for decoding the output tensor.

(12)

An Imaging Device Including:

a processing section configured to select any one of a plurality of DNNs (Deep Neural Networks) with different formats of an output tensor;

a digital signal processing section configured to execute image recognition processing on an input tensor by use of the selected DNN to generate the output tensor;

an output interface configured to output a decode parameter for decoding the generated output tensor and the output tensor; and

an application processor configured to decode the output tensor that has been output, by use of the decode parameter.

(13)

An information processing system including:

a processing section configured to select any one of a plurality of DNNs (Deep Neural Networks) with different formats of an output tensor;

a digital signal processing section configured to execute image recognition processing on an input tensor by use of the selected DNN to generate the output tensor;

an output interface configured to output a decode parameter for decoding the generated output tensor and the output tensor;

an input interface configured to receive the decode parameters corresponding to each of the plurality of DNNs; and

a converter configured to generate each of the decode parameters and supply the generated decode parameter to the input interface.

### REFERENCE SIGNS LIST

100: Imaging device
110: Optical section
120: Application processor
121, 123, 251, 254, 256: Input interface
122, 124, 252, 253, 255: Output interface
130: Flash memory
200: Image sensor
211: Pixel array
212: Analog-digital conversion section
213: Exposure control section
214: Image signal processing section
215: SRAM
216: CPU
217: Hardware accelerator
218: Selector
219: Digital signal processing section
300: DNN converter

1. A solid-state imaging element comprising:
a processing section configured to select any one of a plurality of DNNs (Deep Neural Networks) with different formats of an output tensor;
a digital signal processing section configured to execute image recognition processing on an input tensor by use of the selected DNN to generate the output tensor; and
an output interface configured to output a decode parameter for decoding the generated output tensor and the output tensor.

2. The solid-state imaging element according to claim 1, further comprising:
an input interface configured to receive, as a DNN parameter, a parameter for causing the digital signal processing section to execute each of the plurality of DNNs, wherein
the digital signal processing section executes the image recognition processing on a basis of the DNN parameter.

3. The solid-state imaging element according to claim 1, wherein
the output interface further outputs the input tensor.

4. The solid-state imaging element according to claim 3, further comprising:
a memory configured to store the input tensor in a predetermined area, wherein
the output interface outputs the input tensor read out from the memory, and
the decode parameter includes a persistency flag indicating whether or not the area is not to be overwritten before the image recognition processing is complete.

5. The solid-state imaging element according to claim 3, wherein
the output interface outputs the input tensor and the output tensor to each of which a header is added.

6. The solid-state imaging element according to claim 5, wherein
the header added to the input tensor includes a validity flag indicating whether or not the input tensor is valid, and
the header added to the output tensor includes a validity flag indicating whether or not the output tensor is valid.

7. The solid-state imaging element according to claim 5, wherein
the header added to the input tensor and the header added to the output tensor corresponding to the input tensor include a frame count of a same value.

8. The solid-state imaging element according to claim 1, wherein
the input tensor includes a first input tensor and a second input tensor,
the plurality of DNNs includes a first DNN and a second DNN, and
the digital signal processing section uses the first DNN for the first input tensor and uses the second DNN for the second input tensor.

9. The solid-state imaging element according to claim 1, wherein
the digital signal processing section executes image recognition processing on the input tensor to generate the output tensor, and
the output interface outputs the output tensor after a predetermined frame period elapses in which the input tensor is generated.

10. The solid-state imaging element according to claim 9, wherein
the digital signal processing section suspends the image recognition processing before a capture period in which a frame is held in the memory begins, and resumes the image recognition processing after the capture period elapses.

11. Metadata comprising:
an output tensor generated by image recognition processing executed on an input tensor; and
a decode parameter for decoding the output tensor.

12. An imaging device comprising:
a processing section configured to select any one of a plurality of DNNs (Deep Neural Networks) with different formats of an output tensor;
a digital signal processing section configured to execute image recognition processing on an input tensor by use of the selected DNN to generate the output tensor;
an output interface configured to output a decode parameter for decoding the generated output tensor and the output tensor; and
an application processor configured to decode the output tensor that has been output, by use of the decode parameter.

13. An information processing system comprising:
a processing section configured to select any one of a plurality of DNNs (Deep Neural Networks) with different formats of an output tensor;
a digital signal processing section configured to execute image recognition processing on an input tensor by use of the selected DNN to generate the output tensor;
an output interface configured to output a decode parameter for decoding the generated output tensor and the output tensor;
an input interface configured to receive the decode parameters corresponding to each of the plurality of DNNs; and
a converter configured to generate each of the decode parameters and supply the generated decode parameter to the input interface.
